(19) United States
(12) Patent Application Publication
(10) Pub. No.: US 2006/0090191 A1
(43) Pub. Date: Apr. 27, 2006

(54) Controller device to be connected to tuner device via IEEE 1394 serial bus

(75) Inventor: Atsushi Takagi, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/257,997

(22) Filed: Oct. 26, 2005

(30) Foreign Application Priority Data
Oct. 27, 2004 (JP) 2004-312123

(51) Int. Cl. H04N 7/16

(52) U.S. Cl. 725/153; 725/151

(57) ABSTRACT

When a STB having a tuner device is connected to a DTV for the first time, the DTV creates a channel information DB for the STB based on a channel information DB for the DTV itself. After that, when the STB performs a channel selection operation based on a command from one of controller devices in an IEEE 1394 network and, as a result, the STB receives a broadcast signal on a new channel that is not stored as a receivable channel in the STB channel information DB, the DTV adds the new channel to the DB. When the STB performs a channel selection operation based on a command from the DTV and, as a result, the STB cannot receive a broadcast signal on a channel stored as a receivable channel in the STB channel information DB, the DTV deletes the channel from receivable channels stored in the DB.

### BACKGROUND OF THE INVENTION

1. Field of the Invention

The present invention relates to a controller device such as a digital television receiver or the like that can be connected via an IEEE 1394 serial bus to a device having a tuner function such as a set-top box or the like.

2. Description of the Related Art

A controller device such as a digital television receiver is known in the art that has a tuner circuit therein and can be connected to a device having a tuner function (hereinafter referred to as “tuner device”) such as a set-top box via an IEEE 1394 serial bus. When a user selects a channel to be tuned by a tuner device connected to such a conventional controller device by using a channel-up key or a channel-down key on the controller device, the controller device determines whether or not the selected channel is a channel receivable for the tuner device that is the target, i.e., a channel on which a broadcast signal can be received by the tuner device, based on information in a channel information database (hereinafter referred to as “controller device channel information DB”) that stores information about channels receivable for the tuner circuit provided in the controller device itself.

However, the above described channel determining method has the following problem. For example, assume that a channel 202 (the physical channel number is “2” and the subchannel number is “02”) is stored as a receivable channel in the controller device channel information DB. In this case, even where the controller device has received from the tuner device a response indicating that the tuner device cannot receive a signal on the channel 202 as a result of sending a channel selection command to the tuner device for a channel change to the channel 202, the controller device cannot stop sending again a channel selection command for switching to the channel 202 to the tuner device next time a user presses the channel-up key while a broadcast signal on a channel 201 is received. More particularly, the conventional channel determining method cannot prevent the controller device from repeatedly sending, to the tuner device, a channel selection command for switching to a channel on which a signal cannot be received by the tuner device. Further, since the controller device determines a channel receivable for the tuner device, which is the target, based on the information in the controller device channel information DB as described above, the following inconvenience may also arise. In the case where, for example, a channel 204 (the physical channel number is “2” and the subchannel number is “04”) is not stored as a receivable channel in the controller device channel information DB even though the tuner device can in fact receive a broadcast signal on the channel 204, the controller device cannot send a channel selection command to the tuner device for a channel change to the channel 204 in response to a user's operation of a channel up or down key.

### SUMMARY OF THE INVENTION

An object of the present invention is to provide a controller device to be connected to a tuner device via an IEEE 1394 serial bus that is capable of performing channel control for the tuner device, which is a target, in a way appropriate to a receiving condition of the tuner device.

According to an aspect of the present invention, we provide a controller device connected via an IEEE 1394 serial bus to a device having a tuner function (hereinafter referred to as “tuner device”) in an IEEE 1394 network, the controller device comprising: a tuner circuit capable of receiving a digital television broadcast signal; a channel information database relating to the controller device (hereinafter referred to as “controller device channel information DB”) that stores information about receivable channels on which broadcast signals can be received by the tuner circuit; channel selecting means for entering a selection of a channel to which the tuner device is to be tuned; an IEEE 1394 interface for sending and receiving various kinds of data between the controller device and the tuner device; detecting means for detecting the tuner device connected to the controller device for the first time; tuner device channel information database creating means for, when the detecting means detects the tuner device connected to the controller device for the first time, creating a channel information database relating to the tuner device (hereinafter referred to as “tuner device channel information DB”) that stores information about receivable channels on which broadcast signals can be received by the tuner device based on the information stored in the controller device channel information DB; channel addition means for adding a new channel that is not stored as a receivable channel in the tuner device channel information DB to the receivable channels stored in the tuner device channel information DB when the tuner device performs a channel selection operation based on a command from one of controller devices in the IEEE 1394 network that include the controller device and, as a result, the tuner device receives a broadcast signal on the new channel; and tuner device channel control means for, when detecting a selection of a channel to which the tuner device is to be tuned that is entered by the channel selecting means, performing channel control for the tuner device based on the channel selected by the channel selecting means and on the information about channels receivable for the tuner device that is stored in the tuner device channel information DB.

With the above configuration, the tuner device channel information DB is created based on the controller device channel information DB when the tuner device is connected to the controller device for the first time. After that, when the tuner device performs a channel selection operation based on a command from any one of controller devices in the IEEE 1394 network that include the controller device itself and, as a result, the tuner device receives a broadcast signal on a new channel that is not stored as a receivable channel in the tuner device channel information DB, the new channel is added to the receivable channels stored in the tuner device channel information DB. Thereby, the controller device can keep therein the latest information on channels receivable for the tuner device that is the target so as to perform the channel control for the tuner device in a way appropriate to the receiving condition of the tuner device.

Accordingly, unlike the conventional device, the controller device can send, to the tuner device, a channel selection command for a channel change even to a channel that is not receivable for the controller device but is receivable for the tuner device.

Preferably, the controller device further comprises channel delete means for, when the tuner device performs a channel selection operation based on a command from the controller device and, as a result, the tuner device cannot receive a broadcast signal on a channel stored as a receivable channel in the tuner device channel information DB, deleting the channel on which the broadcast signal cannot be received by the tuner device from the receivable channels stored in the tuner device channel information DB. With this configuration, unlike the conventional device, the controller device can prevent repeated sending, to the tuner device, of a channel selection command for a channel change to a channel on which a broadcast signal cannot be received by the tuner device.

Preferably, the channel selecting means is used to enter a channel-up or channel-down command for changing a channel to which the tuner device is tuned to a next higher or next lower channel, and the tuner device channel control means performs the channel control for the tuner device based on the information about channels receivable for the tuner device that is stored in the tuner device channel information DB when detecting the channel-up or channel-down command entered through the use of the channel selecting means.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a schematic perspective view showing a DTV according to one embodiment of the present invention that is connected to a STB, a DTV, and an AVHDD;

FIG. 2 is an electrical block diagram showing the DTV and the STB;

FIG. 3 is a flowchart showing how the DTV creates and updates a channel information DB relating to the STB; and

FIG. 4 is a flowchart showing a channel control process that the DTV executes when a user performs an operation to select a channel to which the STB is to be tuned.

### DESCRIPTION OF THE PREFERRED EMBODIMENT

Referring now to the accompanying drawings, the preferred embodiment of the present invention is described. The present invention relates to a controller device such as a digital television receiver or the like that can be connected via an IEEE 1394 serial bus to a device having a tuner function (tuner device) such as a set-top box or the like. In the embodiment described below, the present invention is applied to a digital television receiver. It is to be noted that the following description of preferred embodiment of the present invention has been presented for purposes of illustration and description, and is not intended to be exhaustive or to limit the present invention to the precise form disclosed.

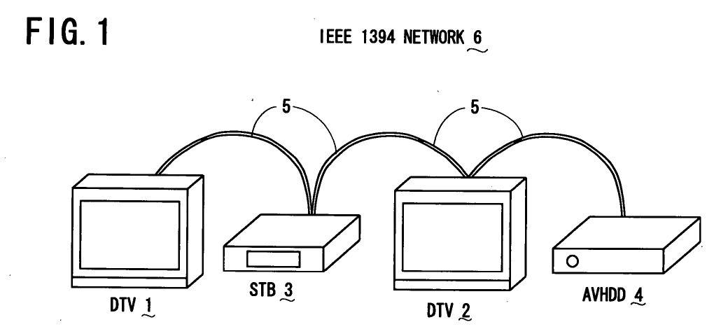

FIG. 1 schematically shows an external view of a digital television receiver 1 (claimed controller device) according to this embodiment that is connected to a set-top box 3, another digital television receiver 2, and an audio/video hard disk drive (AVHDD). Each of the digital television receivers (hereinafter referred to as “DTV”) 1 and 2 has an integrated tuner circuit capable of receiving terrestrial digital television broadcasts. Each of the DTVs 1 and 2 can serve as a controller device (hereinafter referred to simply as “controller”) for the set-top box (hereinafter referred to as “STB”) 3 and the AVHDD 4. The STB 3 also has therein a tuner circuit capable of receiving terrestrial digital television broadcasts so as to output a broadcast signal on a user-selected channel among received broadcast signals. The AVHDD 4 is a hard disk recorder of a type that is capable of recording or reproducing data in response only to a control command conforming to the IEEE 1394 standard. The DTV 1 and the STB 3, the STB 3 and the DTV 2, and the DTV 2 and the AVHDD 4 are connected by IEEE 1394 serial bus cables 5. More particularly, the DTVs 1 and 2, the STB 3, and the AVHDD 4 are included in an IEEE 1394 network 6. This IEEE 1394 network 6 allows a user to, while watching on the DTV 1 a broadcast program on a channel, operate the DTV 1 to enter a command for recording on the AVHDD 4 a broadcast program on another channel that is received by the STB 3. Upon receipt of such a command from a user, the DTV 1 that is the controller needs to send a command for changing the channel (channel selection command) to the STB 3 that is the target. Accordingly, it is desirable that the DTV 1 keeps therein information about channels receivable for the STB 3, i.e., channels on which broadcast signals can be received by the STB 3.

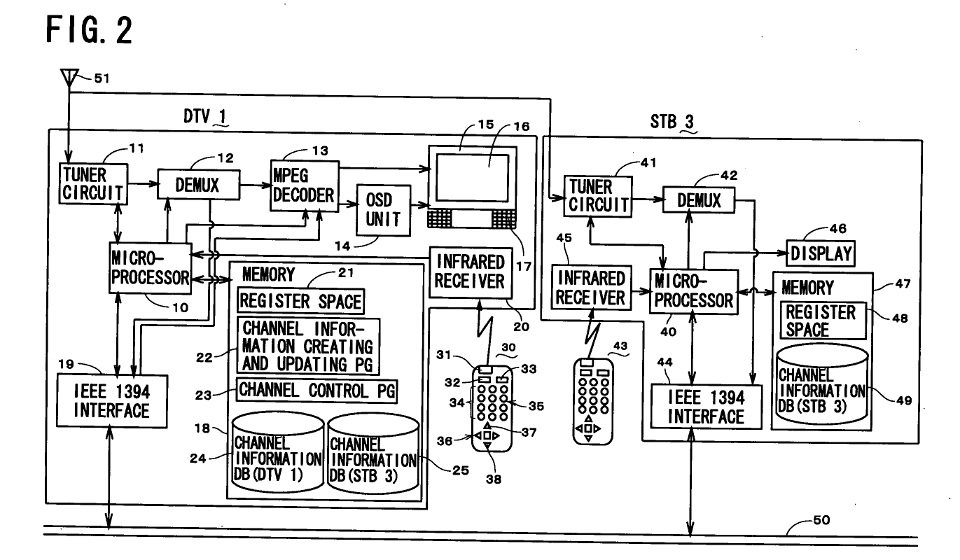

Referring now to FIG. 2, the electrical configuration of the DTV 1 and the STB 3 is described. The DTV 1 is connected to an antenna 51, and comprises the tuner circuit 11 for receiving terrestrial digital television broadcasts, a DEMUX (demultiplexer) 12 for extracting video and audio packets of a user-selected program from a transport stream received by the tuner circuit 11, an MPEG decoder 13 for decoding MPEG compressed video and audio packets received from the DEMUX 12 to reproduce video and audio signals, an on-screen display unit (hereinafter referred to as “OSD unit”) 14 for superimposing a character data signal or the like on the reproduced video signal, and a monitor 15. The monitor 15 includes a screen 16 for displaying a reproduced image and a loudspeaker 17 for outputting a reproduced sound. The DTV 1 further comprises a microprocessor 10 (functioning as e.g. tuner device channel control means, detecting means, tuner device channel information DB creating means, channel addition means, and channel delete means) for controlling each component in the DTV 1, a memory 18 for storing various kinds of data, an IEEE 1394 interface (hereinafter referred to as “interface”) 19 for sending and receiving various kinds of data between the DTV 1 and any other device connected to a bus 50, and an infrared receiver 20 for receiving an infrared signal transmitted from a remote control 30. The memory 18 stores a register space 21 containing various kinds of information concerning the node itself and other nodes on the bus 50, a channel information database (DB) 24 relating to the DTV 1 (claimed controller device channel information DB) containing information about channels receivable for the tuner circuit 11, a channel information database (DB) 25 relating to the STB 3 (claimed tuner device channel information DB) containing information about channels receivable for the STB 3, a channel information creating and updating program (PG) 22 that is a program for creating and updating the channel information DB 25 for the STB 3, and a channel control program (PG) 23 that is a program for channel control performed upon receipt of a selection of a channel to which the STB 3 is to be tuned.

The remote control 30 (claimed channel selecting means) has an infrared transmitter 31 and a key portion 35, where arranged are various keys such as a power key 33, numeric keys 34, cursor keys 36, and a menu key 32 for causing various menus to be displayed. The cursor keys 36 include a channel-up key 37 and a channel-down key 38.

The STB 3 comprises a microprocessor 40 for controlling each component therein. The microprocessor 40 is connected to a tuner circuit 41, a DEMUX (demultiplexer) 42, an IEEE 1394 interface (hereinafter referred to simply as “interface”) 44, an infrared receiver 45, a display 46, and a memory 47.

The tuner circuit 41 can receive terrestrial digital television broadcasts, and extracts a broadcast signal on a user-selected channel from broadcast signals received via the antennal 51. The DEMUX 42 extracts video and audio packets of a user-selected program from a transport stream received by the tuner circuit 41. The interface 44 is an interface circuit for sending and receiving various kinds of data between the STB 3 and any other device on the bus 50. The infrared receiver 45 receives an infrared command signal transmitted from a remote control 43 and converts the command signal into a standard digital signal for output to the microprocessor 40. The display 46 displays various messages for example. The memory 47 stores data such as e.g. a register space 48 containing various kinds of information concerning the node itself (STB 3 itself) and other nodes on the bus 50 and a channel information DB 49 containing information about channels receivable for the STB 3 itself. The remote control 43 is configured similar to the remote control 30 of the DTV 1, and thus the configuration is not repeatedly described.

The DTV 2 shown in FIG. 1 is configured basically identical to the DTV 1. Therefore, the configuration of the DTV 2 is not described.

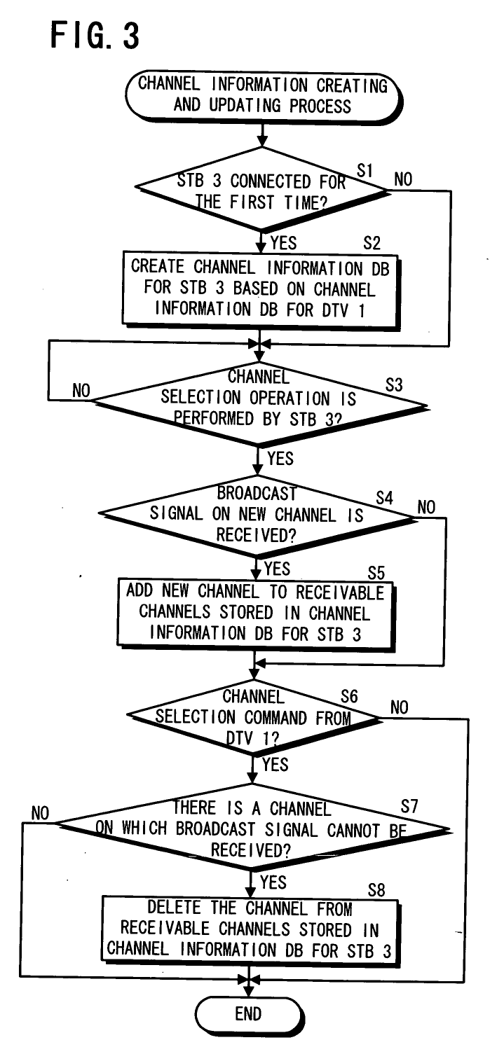

FIG. 3 is a flowchart showing how the DTV 1 creates and updates the channel information DB 25 for the STB 3. When the microprocessor 10 of the DTV 1 detects the STB 3 connected to the IEEE 1394 network 6 (i.e., the STB 3 connected via the bus 50 to the DTV 1), the microprocessor 10 determines whether or not it is the first time that the STB 3 is connected to the DTV 1 based on e.g. a GUID of the STB 3 that is sent from the STB 3. When it is the first time that the STB 3 is connected to the DTV 1 (YES at S1), the microprocessor 10 of the DTV 1 creates the channel information DB 25 for the STB 3, which stores information about channels receivable for the STB 3, based on information contained in the channel information DB 24 for the DTV 1 itself that is stored in the memory 18 (S2), and stores the created channel information DB 25 in the memory 18.

After that, the microprocessor 10 of the DTV 1 checks a channel for a broadcast program being currently received by the STB 3 at all times while the STB 3 is on. When the STB 3 performs a channel selection operation based on a command from any one of controllers in the IEEE 1394 network 6 that include the DTV 1 (YES at S3) and, as a result, the STB 3 receives a broadcast signal on a new channel that is not stored as a receivable channel in the channel information DB 25 for the STB 3 (YES at S4), the microprocessor 10 of the DTV 1 adds the new channel to the receivable channels stored in the channel information DB 25 for the STB 3 (S5).

When the STB 3 performs a channel selection operation based on a channel selection command from the DTV 1 itself (YES at S6) and, as a result, the STB 3 cannot receive a broadcast signal on a channel that is stored as being receivable in the channel information DB 25 for the STB 3 (YES at S7), the microprocessor 10 of the DTV 1 deletes the channel on which the broadcast signal cannot be received by the STB 3 from the receivable channels stored in the channel information DB 25 (S8). On the other hand, in the case where the STB 3 performs a channel selection operation based on a channel selection command from a controller in the IEEE 1394 network 6 other than the DTV 1 (e.g. the DTV 2), the microprocessor 10 of the DTV 1 does not delete a channel from the receivable channels stored in the channel information DB 25 for the STB 3 even if the STB 3 cannot receive a broadcast signal on the channel stored as a receivable channel in the channel information DB 25.

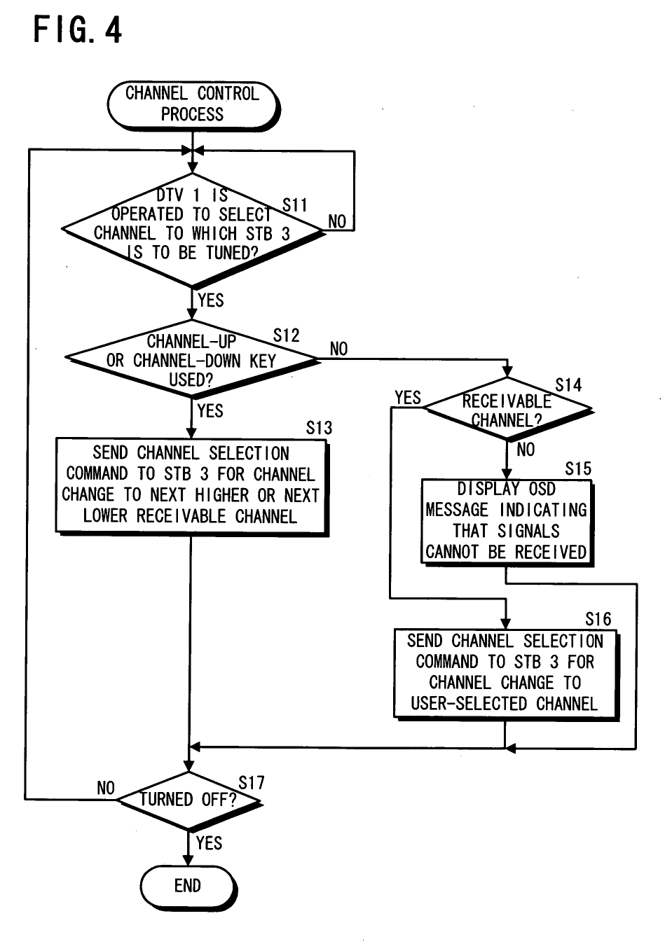

Referring now to the flowchart of FIG. 4, a channel control process is described that is executed on the DTV 1 side when a user operates the DTV 1 to make a selection of a channel to which the STB 3 is to be tuned. When a user selects a channel to which the STB 3 is to be tuned by operating the remote control 30 of the DTV 1 (YES at S11), the microprocessor 10 of the DTV 1 determines whether or not the channel-up key 37 or the channel-down key 38 (see FIG. 2) on the remote control 30 is used to make the channel selection (S12). When the channel-up key 37 or the channel-down key 38 is used for the channel selection (YES at S12), the microprocessor 10 of the DTV 1 reads the information about channels receivable for the STB 3 from the channel information DB 25 to determine a channel receivable for the STB 3 that is next higher (or next lower) than a current channel being tuned by the STB 3, and sends a channel selection command to the STB 3 for a channel change to the next higher (or lower) channel (S13). On the other hand, when a user selects a channel to which the STB 3 is to be tuned by directly inputting the desired channel number without the use of the channel-up key 37 or the channel-down key 38 (NO at S12), the microprocessor 10 of the DTV 1 determines whether or not the channel corresponding to the input number is stored as a channel receivable for the STB 3 in the channel information DB 25 (S14). When YES at the step S14, the microprocessor 10 sends a channel selection command to the STB 3 for a channel change to the user-selected channel (S16). On the other hand, when the channel corresponding to the input number is not stored as a channel receivable for the STB 3 (NO at S14), the microprocessor 10 of the DTV 1 causes the OSD unit 14 to display on the screen 16 a message indicating that broadcast signals on the selected channel cannot be received (S15) while causing the STB 3 to remain tuned to the current channel without sending a channel selection command to the STB 3 for the channel change to the user-selected channel. The microprocessor 10 of the DTV 1 repeats the process of the steps S11 to S16 until the DTV 1 itself or the STB 3 is turned off (NO at S17).

As described above, the DTV 1 according to this embodiment creates the channel information DB 25 for the STB 3 based on information stored in the channel information DB 24 for the DTV 1 when the STB 3 is connected to the DTV 1 for the first time. After that, when the STB 3 performs a channel selection operation based on a command from any one of controllers in the IEEE 1394 network 6 that include the DTV 1 itself and, as a result, the STB 3 receives a broadcast signal on a new channel that is not stored as a receivable channel in the channel information DB 25 for the STB 3, the DTV 1 adds the new channel to receivable channels stored in the channel information DB 25. Further, when the STB 3 performs a channel selection operation based on a command from the DTV 1 itself and, as a result, the STB 3 cannot receive a broadcast signal on a channel stored as a receivable channel in the channel information DB 25 for the STB 3, the DTV 1 deletes the channel on which the broadcast signal cannot be received by the STB 3 from the receivable channels stored in the channel information DB 25. Thereby, the DTV 1 can keep therein the latest information on channels receivable for the STB 3 that is the target so as to perform the channel control for the STB 3 in a way appropriate to the receiving condition of the STB 3.

Accordingly, unlike the conventional device, the DTV 1 (claimed controller device) can prevent repeated sending to the STB 3 (claimed tuner device) of a channel selection command for switching to a channel on which a broadcast signal cannot be received by the STB 3. Further, the DTV 1 can send, to the STB 3, a channel selection command for a channel change even to a channel that is not receivable for the DTV 1 but is receivable for the STB 3.

The present invention has been described above using a presently preferred embodiment, but those skilled in the art will appreciate that various modifications are possible. Accordingly, all such modifications are intended to be included within the spirit and scope of the present invention. For example, the present invention is applied to the DTV in the above described embodiment, but it is also applicable to a STB or any other device that can serve as a controller device. The device having a tuner function (tuner device) for which a channel selection is made by a user is the STB in the above described embodiment, but the tuner device can be another device, e.g., a DTV or a digital video tape recorder (VTR) having an integrated tuner.

This application is based on Japanese patent application 2004-312123 filed Oct. 27, 2004, the contents of which are hereby incorporated by reference.

What is claimed is:

1. A controller device connected via an IEEE 1394 serial bus to a device having a tuner function (hereinafter referred to as “tuner device”) in an IEEE 1394 network, the controller device comprising:
a tuner circuit capable of receiving a digital television broadcast signal;
a channel information database relating to the controller device (hereinafter referred to as “controller device channel information DB”) that stores information about receivable channels on which broadcast signals can be received by the tuner circuit;
channel selecting means for entering a selection of a channel to which the tuner device is to be tuned;
an IEEE 1394 interface for sending and receiving various kinds of data between the controller device and the tuner device;
detecting means for detecting the tuner device connected to the controller device for the first time;
tuner device channel information database creating means for, when the detecting means detects the tuner device connected to the controller device for the first time, creating a channel information database relating to the tuner device (hereinafter referred to as “tuner device channel information DB”) that stores information about receivable channels on which broadcast signals can be received by the tuner device based on the information stored in the controller device channel information DB;
channel addition means for adding a new channel that is not stored as a receivable channel in the tuner device channel information DB to the receivable channels stored in the tuner device channel information DB when the tuner device performs a channel selection operation based on a command from one of controller devices in the IEEE 1394 network that include the controller device and, as a result, the tuner device receives a broadcast signal on the new channel; and
tuner device channel control means for, when detecting a selection of a channel to which the tuner device is to be tuned that is entered by the channel selecting means, performing channel control for the tuner device based on the channel selected by the channel selecting means and on the information about channels receivable for the tuner device that is stored in the tuner device channel information DB.

2. The controller device according to claim 1, further comprising channel delete means for, when the tuner device performs a channel selection operation based on a command from the controller device and, as a result, the tuner device cannot receive a broadcast signal on a channel stored as a receivable channel in the tuner device channel information DB, deleting the channel on which the broadcast signal cannot be received by the tuner device from the receivable channels stored in the tuner device channel information DB.

3. The controller device according to claim 2, wherein the controller device is a digital television receiver.

4. The controller device according to claim 3,
wherein the channel selecting means is used to enter a channel-up or channel-down command for changing a channel to which the tuner device is tuned to a next higher or next lower channel, and
wherein the tuner device channel control means performs the channel control for the tuner device based on the information about channels receivable for the tuner device that is stored in the tuner device channel information DB when detecting the channel-up or channel-down command entered through the use of the channel selecting means.

5. The controller device according to claim 2,
wherein the channel selecting means is used to enter a channel-up or channel-down command for changing a channel to which the tuner device is tuned to a next higher or next lower channel, and
wherein the tuner device channel control means performs the channel control for the tuner device based on the information about channels receivable for the tuner device that is stored in the tuner device channel information DB when detecting the channel-up or channel-down command entered through the use of the channel selecting means.

6. The controller device according to claim 1, wherein the controller device is a digital television receiver.

7. The controller device according to claim 1,
wherein the channel selecting means is used to enter a channel-up or channel-down command for changing a channel to which the tuner device is tuned to a next higher or next lower channel, and
wherein the tuner device channel control means performs the channel control for the tuner device based on the information about channels receivable for the tuner device that is stored in the tuner device channel information DB when detecting the channel-up or channel-down command entered through the use of the channel selecting means.
